(19) United States
(12) Patent Application Publication
(10) Pub. No.: US 2023/0368003 A1
(43) Pub. Date: Nov. 16, 2023

(54) ADAPTIVE SPARSE ATTENTION PATTERN

(71) Applicant: ADOBE INC., SAN JOSE, CA (US)

(72) Inventors: Jiuxiang Gu, Baltimore, MD (US); Zihan Wang, Irvine, CA (US); Jason Wen Yong Kuen, Santa Clara, CA (US); Handong Zhao, San Jose, CA (US); Vlad Ion Morariu, Potomac, MD (US); Ruiyi Zhang, San Jose, CA (US); Ani Nenkova Nenkova, Philadelphia, PA (US); Tong Sun, San Jose, CA (US)

(21) Appl. No.: 17/740,497

(22) Filed: May 10, 2022

(51) Int. Cl. G06N 3/04; G06F 40/284

(52) U.S. Cl. CPC G06N 3/0481; G06F 40/284

(57) ABSTRACT

The technology described herein is directed to an adaptive sparse attention pattern that is learned during fine-tuning and deployed in a machine-learning model. In aspects, a row or a column in an attention matrix with an importance score for a task that is above a threshold importance score is identified. The important row or the column is included in an adaptive attention pattern used with a machine-learning model having a self-attention operation. In response to an input, a task-specific inference is generated for the input using the machine-learning model with the adaptive attention pattern.

### BACKGROUND

The transformer architecture has gained much attention in the natural language processing (NLP) community. Numerous widely known models, such as BERT (Bidirectional Encoder Representations from Transformers), use the transformer architecture. Recently, there have been attempts to design a sparse attention pattern for the transformers. The typical process of learning a transformer model (e.g., BERT) with a sparse attention pattern is to replace the full attention calculation with the known sparse attention pattern, then pre-train the model with the usual pre-training task and fine-tune the model to downstream tasks. There is a need to implement adaptive filters without pre-training the model on the attention pattern.

The known attention patterns may be chosen using the intuition of the developer. Developers are currently limited to selection of known attention patterns and lack a quantifiable way to select the most effective pattern for specific tasks. Accordingly, there is a need for building adaptive sparse attention patterns for specific tasks.

### SUMMARY

The technology described herein is directed at an adaptive sparse attention pattern. The adaptive sparse attention pattern is customized to achieve higher prediction accuracy than the currently available fixed sparse attention patterns. The comparatively higher prediction accuracy may be achieved without using additional computer resources. The adaptive sparse attention pattern may be implemented with less training than is used with the currently available fixed sparse attention patterns

By way of introduction, at a high level, sparse attention patterns reduce computation time and memory used by the attention mechanism in a transformer architecture. These savings are realized by using a subset of attended token pairs in a model layer, rather than using all tokens in the layer. The result of using a sparse attention pattern is a sparse matrix rather than a full matrix.

The technology described herein improves accuracy by identifying the most important task-specific tokens within the transformer model. The most important tokens are those with the largest effect on the final prediction. These important tokens are then included in the adaptive sparse attention pattern. Current methods do not attempt to identify the most important tokens for a specific task. The adaptive sparse attention pattern may also be customized on a layer-by-layer basis, meaning that each layer may have a different adaptive sparse attention pattern that includes tokens determined to be important to that layer for a particular task for which fine-tuning is being performed. This contrasts with the current practice of using the same fixed pattern on each layer.

The technology described herein also eliminates a computationally intensive training step by adding the sparse attention pattern to a pre-trained model, rather than an untrained model. This is in contrast to the typical process used today, which adds the sparse attention pattern to an untrained model. The technology described herein improves upon the current process by adding the sparse attention pattern to the model after the pre-training task is complete on a model with full attention. With the technology described herein, the pre-training is eliminated and only the fine-tuning is performed. This reduces training to the single step of fine-tuning a model that is pre-trained on a full attention pattern.

### BRIEF DESCRIPTION OF THE DRAWINGS

FIG. 1 is an illustration of a work flow for using and training a transformer model with sparse attention patterns, in accordance with embodiments of the technology described herein;

FIG. 2 provides a block diagram of a transformer model without sparse attention patterns, in which embodiments described herein may be employed;

FIG. 3 is an illustration of a transformer model with sparse attention patterns, in accordance with embodiments of the technology described herein;

FIG. 4 is an illustration showing the identification of important attention heads, in accordance with embodiments of the technology described herein;

FIG. 5 provides an example method of training a machine classifier to use a sparse attention pattern, in accordance with embodiments of the technology described herein;

FIG. 6 provides an example method of training a machine classifier to use a sparse attention pattern, in accordance with embodiments of the technology described herein;

FIG. 7 provides an example method of training a machine classifier to use a sparse attention pattern, in accordance with embodiments of the technology described herein; and

FIG. 8 is a block diagram of an example computing environment suitable for use in implementing embodiments of the technology described herein.

### DETAILED DESCRIPTION

The technology described herein is directed at an adaptive sparse attention pattern. The adaptive sparse attention pattern is customized to achieve higher prediction accuracy than currently available fixed sparse attention patterns. The comparatively higher prediction accuracy may be achieved without using additional computer resources. The adaptive sparse attention pattern may be implemented with less training than the currently available fixed sparse attention patterns

By way of introduction, at a high level, sparse attention patterns reduce computation time and memory used by the attention mechanism in a transformer architecture. These savings are realized by using a subset of attended token pairs in a model layer, rather than using all tokens in the layer. The result of using a sparse attention pattern is a sparse matrix rather than a full matrix.

The adaptive sparse attention pattern is customized to achieve higher prediction accuracy than currently available fixed sparse attention patterns by identifying which tokens should be included in the sparse matrix. The most important tokens are those with the largest effect on the final prediction. These important tokens are then included in the adaptive sparse attention pattern. Current methods do not attempt to identify the most important tokens for a specific task. The adaptive sparse attention pattern may also be customized on a layer-by-layer basis, meaning that each layer may have a different adaptive sparse attention pattern that includes tokens determined to be important to that layer for a particular task for which fine-tuning is being performed. This contrasts with the current practice of using the same fixed pattern on each layer.

The technology described herein builds an optimal sparse attention pattern. Intuitively, different tasks prefer different patterns of attention. For example, when people try to solve an entailment task, they will focus on words with similar meanings or opposite meanings to tell whether the two sentences endorse each other Likely, a model with an attention pattern that omnisciently focuses on the attentions between such words would work well. As another example, for NER (“named entity recognition”), the model is likely to focus more on neighbor tokens, rather than longer ranges, to understand the entity boundaries and types. These suggest that different tasks can benefit from different types of attention patterns. The adaptive sparse attention pattern described herein is optimized to the specific task because it is built using the task-specific training data.

The adaptive sparse attention pattern is developed during fine-tuning. At a high level, the most important tokens are identified during fine-tuning. Those tokens indicated as important are then designated as the global tokens, which are used to form an axis aligned attention pattern. Important tokens may be defined as having above a threshold contribution to the accuracy of the final tasks. Without the information provided by these tokens, the final output is less likely to be accurate. As an alternative to a threshold, a top threshold amount (e.g., the top eight tokens) may be identified. The adaptive sparse attention pattern is custom built to include the important tokens in the sparse pattern. The adaptive nature of the adaptive sparse attention pattern contrasts with current technology that attempts to optimize the selection of a fixed sparse attention pattern from known options. Neither the existing patterns nor the existing selection process directly accounts for the relative importance of individual tokens.

The adaptive sparse attention pattern may also be customized on a layer-by-layer basis, meaning that each layer may have a different pattern that includes tokens determined to be important to that layer for a particular task for which fine-tuning is being performed. This contrasts with the current practice of using the same fixed pattern on each layer.

The adaptive sparse attention pattern may be implemented with less training than is used with the currently available fixed sparse attention patterns. The typical training process for a transformer model with or without a sparse attention pattern uses two training steps. The two steps are a pre-training step on generic training data to build a general language understanding and then a fine-tuning step for a specific task. Thus, the current method of training a model with a sparse attention pattern is to add a fixed sparse attention pattern to a model, pre-train on generic data, and then fine tune of task-specific data. In other words, the typical process of training a model with a sparse attention pattern starts the model training over from the beginning by requiring both pre-training and fine-tuning. As used herein, generic training means not task specific.

In contrast to the typical two-step training, the technology described herein improves upon the current process by adding the sparse attention pattern to the model after the pre-training task is complete on a model with full attention (or possibly a different sparse attention pattern). With the technology described herein, the pre-training is eliminated and only the fine-tuning is performed. This reduces training to the single step of fine-tuning a model that is pre-trained on a full attention pattern.

The adaptive sparse attention pattern provides increased accuracy compared to existing sparse attention patterns. Using any sparse attention pattern risks decreased accuracy compared to a full attention pattern, but saves computer memory and other computational resources. The adaptive sparse attention pattern closes the performance gap between a full pattern and a sparse pattern, while maintaining the computer resource savings of a traditional sparse pattern. The increased accuracy is generated by identifying the most important tokens during fine-tuning. Tokens identified as important are then used within the adaptive sparse attention pattern. The accuracy may also be increased by generating a customized sparse attention pattern for each layer. The layer-by-layer approach achieves higher accuracy than using the same pattern with each layer.

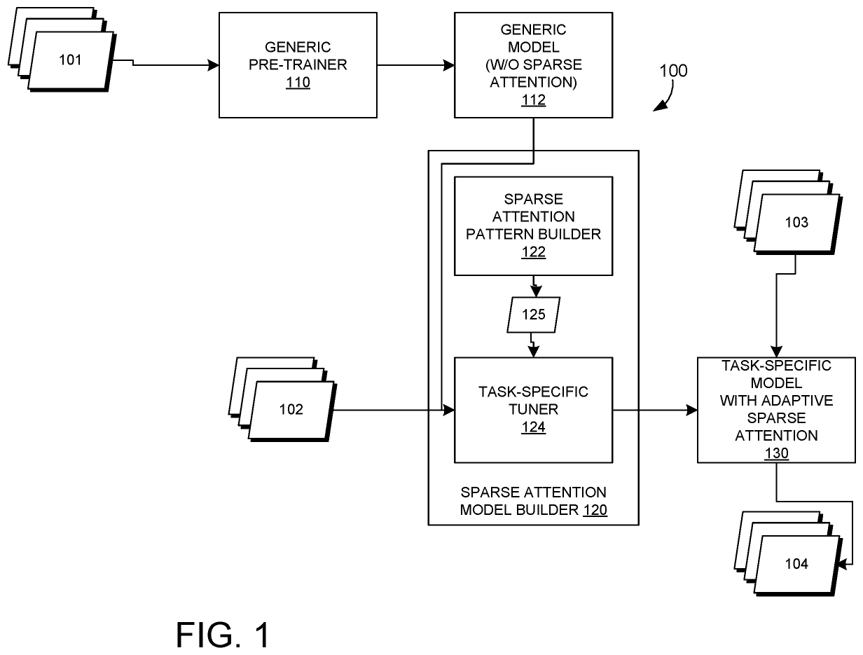

Turning now to FIG. 1, a high-level transformer model in a sparse attention-pattern environment 100 is shown, in accordance with implementations of the present disclosure. The environment 100 includes a pre-trainer 110 and a sparse attention model builder 120. The output is a task-specific model with adaptive sparse attention patterns 130. The sparse attention-pattern environment 100 operates on one or more computing devices that may include client-side devices and server-side devices. In aspects, operations may be split between client-side devices and server-side devices. Further, the components shown may interact with computing devices not shown in FIG. 1, such as user devices. For example, various user interfaces generated by, or with information generated by the components shown, may be displayed on a user device, such as a laptop.

The arrangements described herein are set forth only as examples. Other arrangements and elements (e.g., machines, interfaces, functions, orders, and groupings of functions, etc.) may be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions are carried out by a processor executing instructions stored in memory.

Moreover, these components, functions performed by these components, or services carried out by these components are implemented at appropriate abstraction layer(s), such as the operating system layer, application layer, hardware layer, etc., of the computing system(s). Alternatively, or in addition, the functionality of these components and/or the embodiments of the technology described herein are performed, at least in part, by one or more hardware logic components. For example, and without limitation, illustrative types of hardware logic components include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein regarding specific components shown in example environment 100, it is contemplated that in some embodiments functionality of these components are shared or distributed across other components.

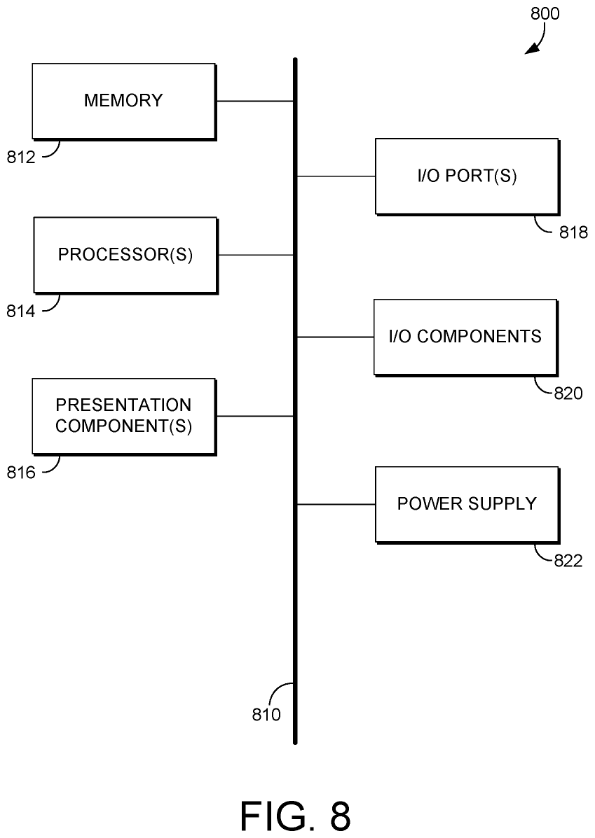

Though not shown, a user device is any type of computing device capable of use by a user. For example, in one embodiment, a user device is of the type of computing device described in relation to FIG. 8 herein. In various embodiments, a user device is a personal computer (PC), a laptop computer, a mobile or mobile device, a smartphone, a tablet computer, a smart watch, a wearable computer, a virtual reality headset, augmented reality glasses, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

The technology described herein will be described in the context of a transformer model, which is a type of model that includes a self-attention layer. Transformer models may be used for natural language processing tasks, such as named-entity recognition. Named-entity recognition (NER) (e.g., entity extraction) is a form of information extraction that seeks to locate and classify named entities mentioned in unstructured text into pre-defined entity classes, such as person names, organizations, locations, time expressions, quantities, monetary values, and the like. Thus, the starting input to a NER system may be unstructured text, such as might be found in an article or document, and the output of the NER system may be a labeled version of the unstructured text where entities are identified into an entity class. While the invention is described in the context of a transformer model herein, the technology may be applied to other models that include self-attention.

The sparse-attention pattern environment includes a generic pre-trainer 110 that uses training data 101 to build a generic model 112 without sparse attention patterns. The term generic means not task specific. For example, generic pre-training for entity extraction may include a large corpus of text and labeled entities. Subsequent fine-tuning may be for a particular type of entity extraction, such as the extraction of medical terms from electronic medical records. The fine-tuning for the entity extraction from medical records would include the use of labeled medical records.

The generic model 112 may be a transformer model with self-attention heads. During the generic training, a full attention pattern is used. With a full attention pattern, every attention head attends every other attention head in the layer and likewise receives attention from every other attention head in the layer. Accordingly, during training, the various learned parameters, such as weight matrices, are learned based on values produced with full attention.

The sparse-attention model builder 120 includes a sparse-attention pattern builder 122, and a task-specific tuner 124. The task-specific tuning component 124 starts with the generic model 112 and uses task specific training data 102 to perform fine-tuning. As mentioned, the generic model will have the values of the learned parameters determined during training with generic data and with full attention.

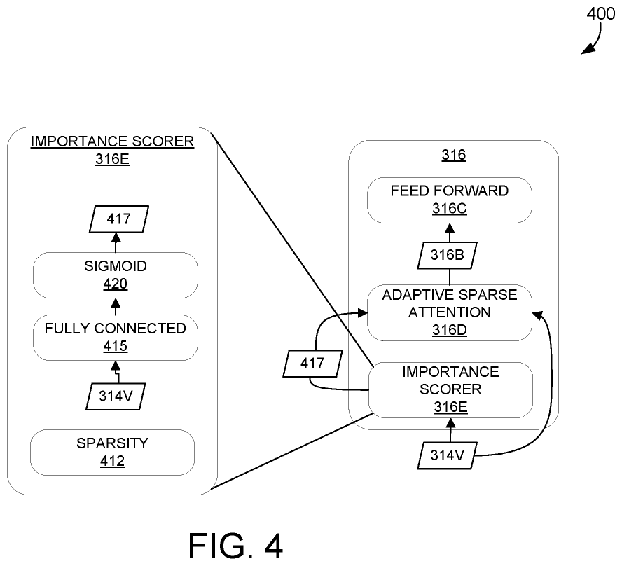

Fine-tuning the model using task specific data improves the model's performance on a specific task. In general, the values assigned to the learned parameters will change during fine-tuning as the model improves at a specific task. During fine-tuning, an importance scorer identifies which tokens are important. The important tokens are used to build an adaptive sparse attention pattern, which may be described as the adaptive axis attention (AAA) pattern. The operations of the importance scorer are described in more detail with reference to FIG. 4. The sparse-attention model builder 122 generates a sparse attention pattern based on the importance score.

The adaptive sparse attention pattern is then added to the generic model 112 during the fine-tuning process to generate a sparse-attention model. The sparse attention pattern replaces the self-attention layer in the generic model. Traditional sparse attention approaches usually learn the sparse attention by replacing the full attention with a pre-defined sparse attention pattern, then learn to operate with such patterns via a normal pre-training and fine-tuning pipeline. The technology described herein, generally does not repeat the normal pre-training and “skips” directly to fine-tuning with the sparse attention pattern. Fine-tuning the generic model with the sparse attention pattern added continues until a trained task-specific model with adaptive sparse attention 130 is generated. The task-specific model with sparse attention 130 is able to receive task inputs 103 (e.g., unlabeled text) and provide a task output 104 (e.g., entity extraction).

The sparse-attention pattern builder 122 builds a custom sparse attention pattern, which may be described as an adaptive axis attention pattern. Generally, the attention patterns can be classified into two categories: (1) the diagonally shaped Diagonal Patterns and its particular case Local Patterns; (2) the vertically and horizontally shaped Axis Patterns, and its particular case of Global Patterns. Sparse attention patterns may be viewed as an attention mask B^{S}∈ [symbol] ^{N×N}, and treated as an additive mask to the original self-attention mask A, The new attention mask Ā can be written as:

Ā=A+C·B^{S} (1)

where C is a large negative constant value, and Bᵢⱼ^{S}∈B^{S} is 1 if and only if token i needs to attend to token j and is zero otherwise.

Local vs. Diagonal Patterns Formally, a diagonal pattern of size N₀ may be defined as a set of user-designed offsets [symbol] ={oₖ}ₖ₌₁^{N}^{ₒ}, and a diagonal attention mask defined as:

Bᵢⱼ^{L}=1⇔|i−j|∈ [symbol] (2)

where oₖ∈[0, N−1] is the offset value that measures the distance between token i and token j.

Local patterns exist in some sparse attention pattern designs where it provides tokens with a local window. Specifically, local patterns can be seen as a special case of diagonal patterns, where oₖ=k, and the offset set is {0}Å [symbol] . For simplicity, and with a slight overriding of the definition of sizes, a local attention of size Nₒ may be described as a diagonal attention with offsets {0, 1, . . . , Nₒ}.

Global vs. Axis Patterns The Axis Attention mask may be composed of two separate sets [symbol] ={rₖ}ₖ₌₁^{N}^{ᵣ}, and C={cₗ}ₗ₌₁^{N}^{_{c}}, and the axis attention mask may be defined as:

Bᵢⱼ^{G}=1⇔∈R or j∈C (3)

where rₖ∈[1, N] and cₗ∈[1, N] are offset values indicating the selected k-th row or l-th column.

Global patterns can be seen as a special case of axis patterns, where rₖ=k and cₗ=1. In other words, in global patterns, there is no difference between horizontal (row) patterns and vertical (column) patterns, and picked rows and columns may be at the start of the input. Global patterns may be seen as an enabler of long-range dependency.

The technology described herein builds an optimal sparse attention pattern. Intuitively, different tasks prefer different patterns of attention. For example, when people try to solve an entailment task, they will focus on words with similar meanings or opposite meanings to tell whether the two sentences endorse each other Likely, a model with an attention pattern that omnisciently focuses on the attentions between such words would work well. As another example, for NER (“named entity recognition”), the model is likely to focus more on neighbor tokens, rather than longer ranges, to understand the entity boundaries and types. These suggest that different tasks can benefit from different types of attention patterns. The sparse-attention model builder 122 may build an optimized pattern for each task. The optimized sparse-attention pattern may be different for each encoder layer.

The sparse-attention pattern builder 122 receives the important tokens from the importance scorer. In an aspect, the importance scorer may provide the most important rows and columns to include in the sparse-attention pattern. The importance of a row or column is based on the tokens associated with these rows or columns. If the most important rows and columns are not layer specific, then this sparse-attention pattern may be described as task-adaptive. The pattern is task adaptive because the important rows and columns were determined based on task-specific training data. If the sparse-attention pattern is layer-specific, meaning that the most important rows and columns for each layer are used to select rows and columns for each layer, then the pattern may be described as task and layer adaptive. In one aspect, a task-adaptive pattern or task and layer-adaptive pattern is paired with global attention to produce the final sparse attention pattern 125 used in the model. Global patterns allow some specially designated tokens to attend to all other tokens, while the undesignated tokens are allowed to attend only to the specially designated tokens.

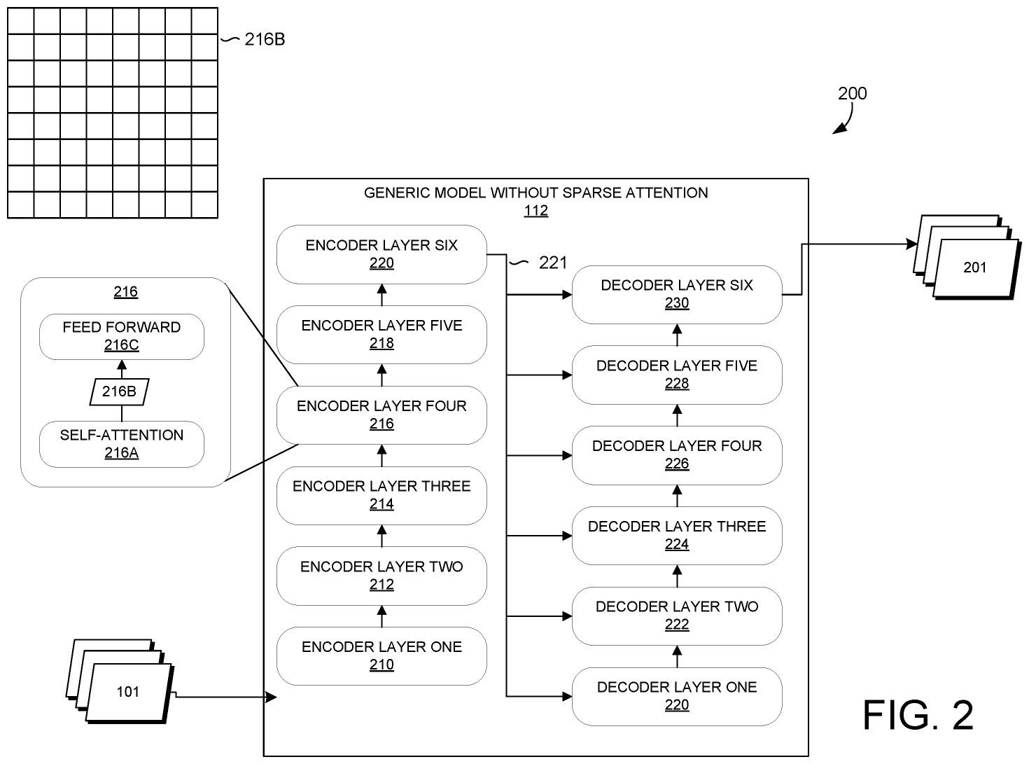

Turning now to FIG. 2, a transformer architecture 200 is illustrated without a sparse attention pattern, according to aspects of the technology described herein. The transformer architecture 200 is of an encoder-decoder model. Aspects of the technology are not limited to use with encoder-decoder models. For example, the adaptive sparse attention patterns can be used in encoder only models. The technology described herein may be used in models with self-attention operations. As mentioned, a first step in building the task-specific model with adaptive sparse attention 130 is to train a transformer model without sparse attention 112. FIG. 2 illustrates the first training step that may be used with the technology described herein. The transformer architecture 200 operates on one or more computing devices that may include client-side devices and server-side devices. In aspects, operations may be split between client-side devices and server-side devices. The arrangements described herein are set forth only as examples. Other arrangements and elements (e.g., machines, interfaces, functions, orders, and groupings of functions, etc.) may be used in addition to or instead of those shown, and some elements may be omitted altogether for the sake of clarity. For example, various encoders and decoders may include layer normalization functions that are not described herein.

At a high level, the generic transformer model 112 can receive an input 101 and produce an output related to the input 201. The input 101 could be training data or, once the generic model 110 is trained, an input 101 to be processed. The input 101 can take different forms depending on the task being performed. For example, the input 101 could be a sentence in a first language and the output 102 a translation of the sentence into a second language. In other examples, the output 201 could be an entity extraction, or a classification. Different models may be trained to produce different outputs. In addition to natural language processing tasks, transformers may also be used in computer vision tasks, such as facial recognition and object recognition.

At a very high level, transformers may be encoder-decoder models, where the encoder coverts the input 101 to a vector. Using language translation as an example, the input 101 could be a sentence. As a pre-processing step, the input may be converted to a vector, which may be described as embedding. The encoder will convert the text embedding into a vector. The vector is passed to the decoder. The decoder produces an output 102, such as a translated sentence.

As shown in FIG. 2, the encoder may include a stack of encoders. The stack of encoders includes a layer-one encoder 210, a layer-two encoder 212, a layer-three encoder 214, a layer-four encoder 216, a layer-five encoder 218, and a layer-six encoder 220. Similarly, the decoder may include a stack of decoders. The encoders have a similar structure and similar layers in them. However, the weights in each encoder layer may be different and are learned during the training process. Aspects of the technology described herein are not limited to use with six layer transformers.

The stack of decoders includes a layer-one decoder 230, a layer-two decoder 232, a layer-three decoder 234, a layer-four decoder 236, a layer-five decoder 238, and a layer-six decoder 240. The decoders have a similar structure and similar layers in them. However, the weights in each decoder layer may be different and are learned during the training process. Aspects of the technology described herein are not limited to use with six layer transformers.

The input 101 is provided to the layer-one encoder 210. The input may be an embedding produced from a precedent input, such as a sentence. The embedding may be produced by an embedding algorithm, such as Word2Vec. The embedding is only input to the layer-one encoder 210. The other encoders receive the output of the encoder that is directly below. In one aspect, the input 101 and the outputs from the encoders may have the same size.

The layer-one encoder 210 produces a first encoder vector by processing the input 101. The first encoder vector is communicated to the layer-two encoder 212, which performs operations on the first encoder vector to generate a second encoder vector. The second encoder vector is communicated to the layer-three encoder 214, which performs operations on the second vector to generate a third encoder vector. The third encoder vector is communicated to the layer-four encoder 216, which performs operations on the third encoder vector to generate a fourth encoder vector. The fourth encoder vector is communicated to the layer-five encoder 218, which performs operations on the fourth encoder vector to generate a fifth encoder vector. The fifth encoder vector is communicated to the layer-six encoder 220, which performs operations on the fifth encoder vector to generate a sixth encoder vector 221. The sixth encoder vector 221 is passed to each decoder in the decoder stack.

The sixth encoder vector 221 is provided to the layer-one decoder 220. The layer-one decoder 220 produces a first decoder vector by processing the sixth vector 221. The first decoder vector is communicated to the layer-two decoder 222, which performs operations on the first decoder vector and the sixth encoder vector 221 to generate a second decoder vector. The second decoder vector is communicated to the layer-three decoder 224, which performs operations on the second decoder vector and the sixth encoder vector 221 to generate a third decoder vector. The third decoder vector is communicated to the layer-four decoder 226, which performs operations on the third decoder vector and the sixth encoder vector 221 to generate a fourth decoder vector. The fourth decoder vector is communicated to the layer-five decoder 238, which performs operations on the fourth decoder vector and the sixth encoder vector 221 to generate a fifth decoder vector. The fifth decoder vector is communicated to the layer-six decoder 230, which performs operations on the fifth decoder vector and the sixth encoder vector 221 to generate a sixth decoder vector. The sixth decoder vector is an output 201 of the generic transformer model.

Taking a closer look at layer-four encoder 216, shows that it includes a self-attention layer 216A and a feed forward neural network 216C. The Z vector (or matrix) 216B output from the self-attention layer 216A is input to the feed forward neural network 216C, which produces the fourth vector described previously. As mentioned, the fourth vector is an input to the layer-five encoder 218. The sparse attention patterns described herein change the calculations made at the self-attention layer 216A and might produce a different Z vector (or matrix) 216B.

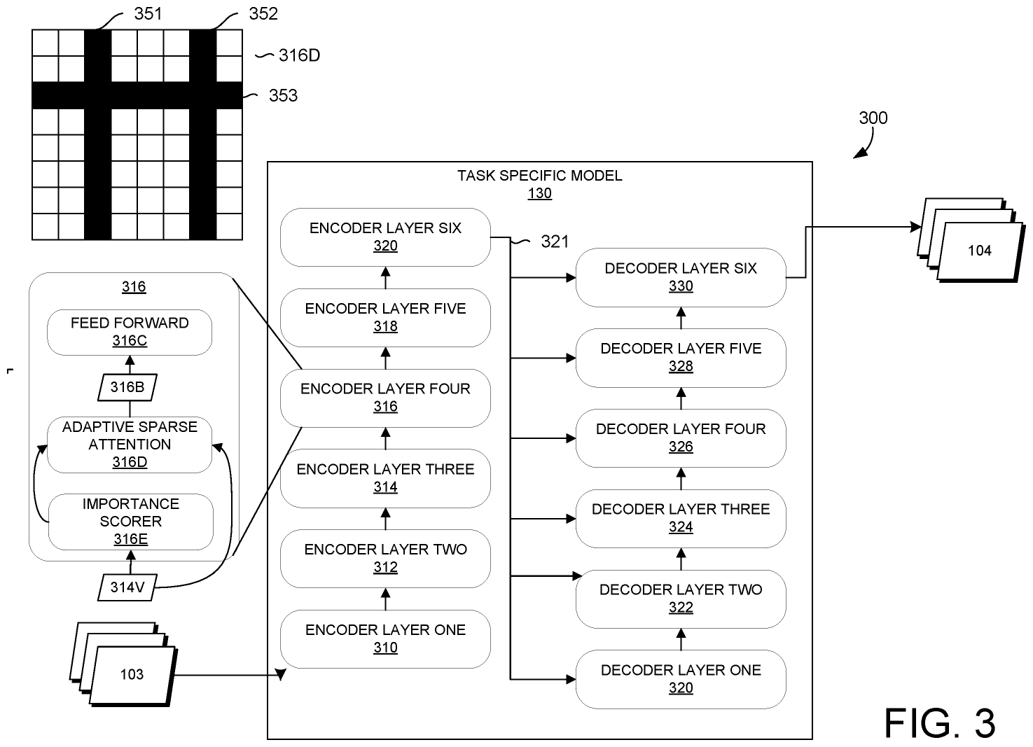

Turning now to FIG. 3, a transformer architecture 300 is illustrated with a sparse attention pattern, according to aspects of the technology described herein. The transformer architecture 300 may start with the transformer model shown in FIG. 2, which has been trained on a generic task. The transformer architecture 300 operates on one or more computing devices that may include client-side devices and server-side devices. In aspects, operations may be split between client-side devices and server-side devices. The arrangements described herein are set forth only as examples. Other arrangements and elements (e.g., machines, interfaces, functions, orders, and groupings of functions, etc.) may be used in addition to or instead of those shown, and some elements may be omitted altogether for the sake of clarity.

Many of the components of the task-specific model with adaptive sparse attention 130 have the same arrangement and function as in FIG. 2. However, the values associated with various components change during fine-tuning. For example, the trainable values in the feed forward layers may initially match those at the end of the generic training. The trainable values associated with the feed forward layers may change during fine-tuning. The stack of encoders includes a layer-one encoder 310, a layer-two encoder 312, a layer-three encoder 314, a layer-four encoder 316, a layer-five encoder 318, and a layer-six encoder 320. The stack of decoders includes a layer-one decoder 330, a layer-two decoder 332, a layer-three decoder 334, a layer-four decoder 336, a layer-five decoder 338, and a layer-six decoder 340.

Taking a closer look at layer-four encoder 316, shows that it includes an importance scorer 316E, adaptive sparse attention pattern 316D, and a feed forward neural network 316C. In transformer architecture 300, an adaptive sparse attention pattern, such as adaptive sparse attention pattern 316D, is added to each encoder layer. The adaptive sparse attention pattern 316D replaces the self-attention layer 216A of the transformer architecture 200. Each encoder layer may also include an importance scorer 316E. The importance scorer 316E receives an output vector from the previous encoding layer. In the example shown, the third output vector 314V is input to the importance scorer 316E. The importance scorer 316E determines the most important tokens and/or rows and columns in the specific encoding layer that include the most important tokens. These tokens or rows and columns are used to build the adaptive sparse attention pattern 316D. In general, the adaptive sparse attention pattern causes tokens in the designated rows and/or columns to receive and/or give attention. The subset is represented by the first black column 351, a second black column 352, and a black row 353.

The third output vector 314V is input to both the adaptive sparse attention pattern 316D, which produces a Z vector (or matrix) 316B, and the importance scorer 316E. The Z vector 316B is input to the feed forward 316C layer, which produces the fourth vector described previously. As mentioned, the fourth vector is an input to the layer-five encoder 318.

Turning now to FIG. 4, a operating environment 400 for the importance scorer 316E is provided, according to aspects of the technology described herein. The environment 400 operates on one or more computing devices that may include client-side devices and server-side devices. In aspects, operations may be split between client-side devices and server-side devices. The arrangements described herein are set forth only as examples. Other arrangements and elements (e.g., machines, interfaces, functions, orders, and groupings of functions, etc.) may be used in addition to or instead of those shown, and some elements may be omitted altogether for the sake of clarity.

The importance scorer 316E includes a sparsity component 412, a fully connected layer 415, and sigmoid function 420, which generates the row or column score 417 used to build the adaptive sparse attention pattern 316D. The sparsity component 412 calculates a sparsity score for a sparse attention pattern. Sparsity measures the size of the sparse attention (fixed or learned) when compared with the full attention. The size of the sparse attention may be defined as an amount of self-attention operations performed. The sparsity component 412 can help build a sparse-attention pattern that uses a desired amount of computing resources. A purpose of using sparse attention patterns is to reduce computer usage. The sparsity score can be used to build a sparse attention pattern with the desired computer usage.

As the technology described herein generates a better performing sparse attention pattern, a starting point can be an existing sparse attention pattern that uses the desired amount of computing resources. The sparsity component 412 can generate a sparsity measure for the existing pattern and then build a sparse attention pattern that has a similar sparsity score, and should use similar computer resources as the existing pattern.

In aspects, the generalized definition of sparsity is represented as:

$$ρ = \frac{1}{\vert D \vert Lh} {\sum }_{i = 1}^{\vert D \vert} ( {\sum }_{l = 1}^{L} {\sum }_{a = 1}^{h} ( 1 - \frac{\vert {B}_{i , l , a}^{S} \vert}{{N}_{i}^{2}} ) ) \qquad ( 4 )$$

where |D| is the size of the dataset D, Nᵢ denotes the sequence length of the i-th input sample, which can be different from the fixed value (128), L the number of transformer layers, and h number of attention heads. B_{i,l,a}^{S} refers to the sparse attention mask matrix for the i-th input sample, l-th layer, and a-th attention head.

This sparsity pattern recognizes that sparsity patterns can be different across instances, layers, and attention heads. This pattern also uses the actual sequence length of the input, rather than the model wide maximum length. This sparsity measure more accurately reflects how much attention is given each input.

In aspects, the sparsity pattern is used to perform sparsity-controlled pattern generation. Given the sparsity ρ_{target}, which may be a fixed target, the training object may be defined as follows:

$${ℒ}_{All} = {\underbrace{{ℒ}_{task}}}_{Finetune Loss} + {\underbrace{α \cdot max ( 0 , {ρ}_{target} - ρ )}}_{Sparsity Loss} \qquad ( 5 )$$

where the first term ( [symbol] ₜₐₛₖ) denotes the objective loss for the fine-tuning task. ρ is the sparsity during training, α is an amplifying factor of the sparsity loss. The hinge loss encourages the runtime sparsity to be close to the desired sparsity. In aspects, two variants of α: 1) a constant value and 2) an increasing linear value that reaches its maximum at half of the epochs and then stays constant, are selected. In aspects, the best variant of a among the two is selected during training. The absolute value of α may gradually increase until the target sparsity has been reached.

As previously mentioned, the importance scorer 316E includes a fully connected layer 415 that receives a fourth output vector 314V from the layer-three encoder 314 and produces an output that is provided to the Gumble sigmoid function 420. Though just shown for the layer-four encoder 316, a similar process may be performed on each encoder layer to determine the most important rows and columns for each encoder layer. The important positions 417 are identified by the Gumble sigmoid function 420 and used to build the adaptive sparse attention pattern 316D.

Specifically the importance scorer 316E learns a row/column-wise importance value for each token representation xₙ∈X through a fully-connected layer 415. The importance value is fed to a sigmoid function 420, such as a Gumble sigmoid operation to retrieve a 0/1 indication:

Ĩₙ^{k}=f_{Gumbel-sigmoid} (f_{FC}^{k}(xₙ)), k∈{r, c} (6)

Where Ĩₙ^{k} is the importance indicator for the n-th token retrieved by the Gumbel-sigmoid operation, k indicates the column (c) or row (r). Specifically, Ĩₙ^{r}=1 indicates that all attention values in row n of the attention matrix are kept. Equivalently, this means this certain token can attend to all other tokens during attention. Similarly, Ĩₙ^{c}=1 indicates column n of the attention matrix is kept.

Given the importance indicators Ĩᵢ^{r} and Ĩⱼ^{c}, the axis pattern Bᵢⱼ^{S}∈B^{S} may be calculated as follows:

Bᵢⱼ^{S}=Ĩᵢ^{r}+Ĩⱼ^{c}−Ĩᵢ^{r}·Ĩⱼ^{c} (7)

where Bᵢⱼ^{S}=1 means either the importance indicator for row i or column j is on.

In aspects, this adaptive axis attention pattern may also be paired up with some local patterns, for example, the main diagonal local attention. The pairing is to ensure that no rows are empty (self-attention includes operations such as softmax and linear combinations, which is undefined over empty values). In an aspect, the adaptive axis attention pattern may be paired up with a local pattern of size 2. This adaptive axis pattern is also learned separately for each layer and different tasks, thus utilizing the benefits of adaptiveness.

The columns and rows identified as important may be provided to the sparse attention pattern builder 122. The sparse attention pattern builder builds a sparse attention pattern that includes these columns and rows. Including these rows and columns in the pattern means that the included rows and patters receive and give attention.

### EXEMPLARY METHODS

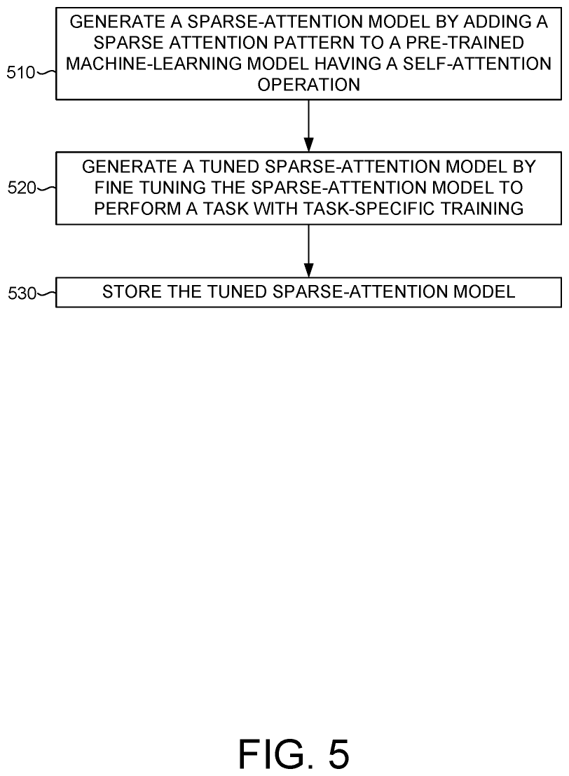

Now referring to FIGS. 5-7, each block of methods 500, 600, and 700, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by a standalone application, a service or hosted service (standalone or in combination with another hosted service), to name a few. In addition, methods 500, 600, and 700 are described, by way of example, with respect to the sparse-attention model builder 120 of FIG. 1 and additional features of FIGS. 2-4. However, these methods may additionally or alternatively be executed by any one system, or any combination of systems, including, but not limited to, those described herein.

FIG. 5 is a flow diagram showing a method 500 for training a machine classifier to use a sparse attention pattern, in accordance with some embodiments of the present disclosure. The method 500, at block 510 includes generating a sparse-attention model by adding a sparse attention pattern to a pre-trained machine-learning model having a self-attention operation. The pre-trained machine-learning model may be a transformer model with self-attention heads. The pre-trained machine-learning model is trained on generic data. The term generic means not task specific. For example, generic pre-training for entity extraction may include a large corpus of text and labeled entities. Subsequent fine-tuning may be for a particular type of entity extraction, such as the extraction of medical terms from electronic medical records. The fine-tuning for the entity extraction from medical records could include the use of labeled medical records.

The pre-trained machine-learning model is trained with a full attention pattern. With a full attention pattern, every attention head attends every other attention head in the layer and likewise receives attention from every other attention head in the layer. Accordingly, during training of the pre-trained machine-learning model, the various learned parameters, such as weight matrices, are learned based on values produced with full attention

The sparse attention pattern, which may be an adaptive sparse attention matter, is then added to the pre-trained machine-learning model to generate a sparse-attention model. The sparse attention pattern replaces the self-attention layer in the pre-trained machine-learning model (e.g.,) generic model.

The method 500, at block 520 includes fine-tuning the sparse-attention model to perform a task with task-specific training data. The task-specific training data contrasts with generic data. Traditional sparse attention approaches replace the full attention pattern with a pre-defined sparse attention pattern, then train the sparse attention model via a normal generic pre-training followed by fine-tuning on task-specific data. The technology described herein, does not repeat the normal generic pre-training with a sparse attention pattern and instead “skips” directly to fine-tuning with the sparse attention pattern. In other words, the starting point for fine tuning is a model with parameters learned with generic data and full attention. The full attention is replaced with sparse attention and then fine-tuning begins with task specific data. Fine-tuning the pre-trained machine-learning model with the sparse attention pattern continues until a trained task-specific model with sparse attention is generated. The task-specific model with sparse attention is able to receive task inputs (e.g., unlabeled text) and provide a task output (e.g., entity extraction, inference).

The method 500, at block 530 includes storing the sparse-attention model. The sparse-attention model is stored in computer memory. The sparse-attention model may be accessed and used for various tasks.

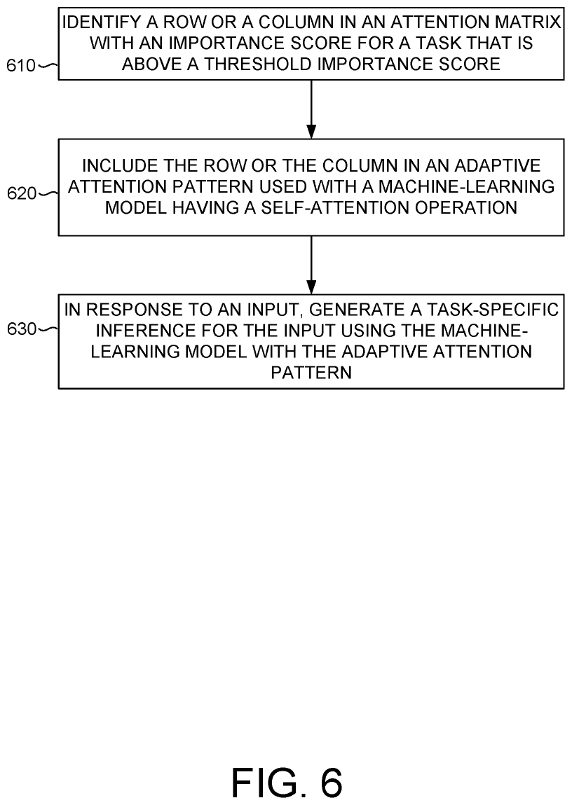

FIG. 6 is a flow diagram showing a method 600 for training a machine classifier to use a sparse attention pattern, in accordance with some embodiments of the present disclosure. The method 600, at block 610 includes identifying a row or a column in an attention matrix with an importance score for a task that is above a threshold importance score. The importance of a row or column is based on the tokens associated with these rows or columns. If the most important rows and columns are not layer specific, then this sparse-attention pattern may be described as task-adaptive. The pattern is task adaptive because the important rows and columns were determined based on task-specific training data. If the sparse-attention pattern is layer-specific, meaning that the most important rows and columns for each layer are used to select rows and columns for each layer, then the pattern may be described as task and layer adaptive.

[symbol]

The method 600, at block 620 includes including the row or the column in an adaptive attention pattern used with a machine-learning model having a self-attention operation. Including these rows and columns in the adaptive attention pattern means that the included rows and patters receive and give attention during the self-attention operations.

The method 600, at block 630 includes, in response to an input, generating a task-specific inference for the input using the machine-learning model with the adaptive attention pattern. The input could be a block of text or other natural language content. The inference could be a sentiment, entity extraction, or other natural language processing output. In other aspects, the input could be an image and the output an identification of an object depicted in the image. Aspects of the technology are not limited to use with these example inferences.

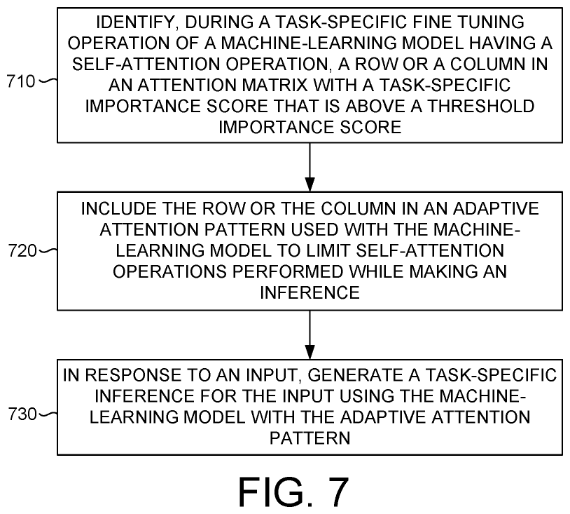

FIG. 7 is a flow diagram showing a method 700 for training a machine classifier to use a sparse attention pattern, in accordance with some embodiments of the present disclosure. The method 700, at block 710 includes identifying, during a task-specific fine-tuning operation of a machine-learning model having a self-attention operation, a row or a column in an attention matrix with a task-specific importance score that is above a threshold importance score. The importance of a row or column is based on the tokens associated with these rows or columns. If the most important rows and columns are not layer specific, then this sparse-attention pattern may be described as task-adaptive. The pattern is task adaptive because the important rows and columns were determined based on task-specific training data. If the sparse-attention pattern is layer-specific, meaning that the most important rows and columns for each layer are used to select rows and columns for each layer, then the pattern may be described as task and layer adaptive.

Aspects of the technology may determine the importance of rows and columns during the fine-tuning process, which occurs with task-specific training data. Determining the importance of rows and columns during task-specific training contrasts with determining the importance of rows and columns during generic training, which may be described herein as pre-training.

The method 700, at block 720 includes including the row or the column in an adaptive attention pattern used with the machine-learning model to limit self-attention operations performed while making an inference. Including these rows and columns in the adaptive attention pattern means that the included rows and patters receive and give attention during the self-attention operations.

The method 700, at block 730 includes, in response to an input, generating a task-specific inference for the input using the machine-learning model with the adaptive attention pattern. The input could be a block of text or other natural language content. The inference could be a sentiment, entity extraction, or other natural language processing output. In other aspects, the input could be an image and the output an identification of an object depicted in the image. Aspects of the technology are not limited to use with these example inferences.

### Exemplary Operating Environment

Having briefly described an overview of embodiments of the present invention, an example operating environment in which embodiments of the present invention may be implemented is described below in order to provide a general context for various embodiments of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are contemplated. For example, one may consider a presentation component such as a display device to be an I/O component. In addition, processors have memory. Such is the nature of the art, and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may include computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

With reference to the technical solution environment described herein, embodiments described herein support the technical solution described herein. The components of the technical solution environment can be integrated components that include a hardware architecture and a software framework that support constraint computing and/or constraint querying functionality within a technical solution system. The hardware architecture refers to physical components and interrelationships thereof, and the software framework refers to software providing functionality that can be implemented with hardware embodied on a device.

The end-to-end software-based system can operate within the system components to operate computer hardware to provide system functionality. At a low level, hardware processors execute instructions selected from a machine language (also referred to as machine code or native) instruction set for a given processor. The processor recognizes the native instructions and performs corresponding low-level functions relating, for example, to logic, control and memory operations. Low-level software written in machine code can provide more complex functionality to higher levels of software. As used herein, computer-executable instructions includes any software, including low level software written in machine code, higher level software such as application software and any combination thereof. In this regard, the system components can manage resources and provide services for system functionality. Any other variations and combinations thereof are contemplated with embodiments of the present invention.

By way of example, the technical solution system can include an API library that includes specifications for routines, data structures, object classes, and variables may support the interaction between the hardware architecture of the device and the software framework of the technical solution system. These APIs include configuration specifications for the technical solution system such that the different components therein can communicate with each other in the technical solution system, as described herein.

The technical solution system can further include a machine-learning system. A machine-learning system may include machine-learning tools and training components. Machine-learning systems can include machine-learning tools that are utilized to perform operations in different types of technology fields. Machine-learning systems can include pre-trained machine-learning tools that can further be trained for a particular task or technological field. At a high level, machine learning is a field of study that gives computers the ability to learn without being explicitly programmed. Machine learning explores the study and construction of machine-learning tools, including machine-learning algorithm or models, which may learn from existing data and make predictions about new data. Such machine-learning tools operate by building a model from example training data in order to make data-driven predictions or decisions expressed as outputs or assessments. Although example embodiments are presented with respect to a few machine-learning tools, the principles presented herein may be applied to other machine-learning tools. It is contemplated that different machine-learning tools may be used, for example, Logistic Regression (LR), Naive-Bayes, Random Forest (RF), neural networks (NN), matrix factorization, and Support Vector Machines (SVM) tools may be used for addressing problems in different technological fields.

In general, there are two types of problems in machine-learning: classification problems and regression problems. Classification problems, also referred to as categorization problems, aim at classifying items into one of several category values (for example, is this email SPAM or not SPAM). Regression algorithms aim at quantifying some items (for example, by providing a value that is a real number). Machine-learning algorithms can provide a score (e.g., a number from 1 to 100) to qualify one or more products as a match for a user of the online marketplace. It is contemplated that cluster analysis or clustering can be performed as part of classification, where clustering refers to the task of grouping a set of objects in such a way that objects in the same group (called a cluster) are more similar (in some sense) to each other than to those in other groups (clusters). It is a main task of exploratory data mining, and a common technique for statistical data analysis, used in many fields, including pattern recognition, image analysis, information retrieval, bioinformatics, data compression, computer graphics and machine learning.

Machine-learning algorithms utilize the training data to find correlations among identified features (or combinations of features) that affect an outcome. A trained machine-learning model may be implemented to perform a machine-learning operation based on a combination of features. An administrator of a machine-learning system may also determine which of the various combinations of features are relevant (e.g., lead to desired results), and which ones are not. The combinations of features determined to be (e.g., classified as) successful are input into a machine-learning algorithm for the machine-learning algorithm to learn which combinations of features (also referred to as “patterns”) are “relevant” and which patterns are “irrelevant.” The machine-learning algorithms utilize features for analyzing the data to generate an output or an assessment. A feature can be an individual measurable property of a phenomenon being observed. The concept of feature is related to that of an explanatory variable used in statistical techniques such as linear regression. Choosing informative, discriminating, and independent features is important for effective operation of the machine-learning system in pattern recognition, classification, and regression. Features may be of different types, such as numeric, strings, and graphs.

The machine-learning algorithms utilize the training data to find correlations among the identified features that affect the outcome or assessment. The training data includes known data for one or more identified features and one or more outcomes. With the training data and the identified features the machine-learning tool is trained. The machine-learning tool determines the relevance of the features as they correlate to the training data. The result of the training is the trained machine-learning model. When the machine-learning model is used to perform an assessment, new data is provided as an input to the trained machine-learning model, and the machine-learning model generates the assessment as output.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments that are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A method comprising:
identifying a row or a column in an attention matrix with an importance score for a task that is above a threshold importance score;
including the row or the column in an adaptive attention pattern used with a machine-learning model having a self-attention operation; and
in response to an input, generating a task-specific inference for the input using the machine-learning model with the adaptive attention pattern.

2. The method of claim 1, wherein the adaptive attention pattern is for a single layer of the machine-learning model.

3. The method of claim 1, wherein the adaptive attention pattern assigns global attention to tokens in the row or the column.

4. The method of claim 1, wherein the adaptive attention pattern is a merger of the row or the column with a diagonal attention pattern.

5. The method of claim 1, wherein the importance score is generated during fine tuning of the machine-learning model with task-specific training data.

6. The method of claim 1, wherein the machine-learning model having the self-attention operation is a transformer model.

7. A non-transitory computer-readable medium storing computer-executable instructions that, when executed by a processing device, cause the processing device to perform operations comprising:
generating a sparse-attention model by adding a sparse attention pattern to a pre-trained machine-learning model having a self-attention operation;
generating a tuned sparse-attention model by fine tuning the sparse-attention model to perform a task with task-specific training; and
storing the tuned sparse-attention model.

8. The non-transitory computer-readable medium of claim 7, wherein the sparse attention pattern is an adaptive attention pattern.

9. The non-transitory computer-readable medium of claim 8, wherein the adaptive attention pattern is learned during the training of the untrained sparse-attention model with task specific training data.

10. The non-transitory computer-readable medium of claim 8, wherein the adaptive attention pattern includes a row or a column in an attention matrix with a task-specific importance score that is above a threshold importance score.

11. The non-transitory computer-readable medium of claim 8, wherein the adaptive attention pattern assigns global attention to tokens in the row or the column.

12. The non-transitory computer-readable medium of claim 7, wherein the pre-trained machine-learning model is trained on a generic task.

13. The non-transitory computer-readable medium of claim 7, wherein the machine-learning model is not retrained on a generic task after adding the adaptive attention pattern to the machine-learning model.

14. A system comprising:
a memory component; and
a processing device coupled to the memory component, the processing device to perform operations comprising:
identifying, during a task-specific fine tuning operation of a machine-learning model having a self-attention operation, a row or a column in an attention matrix with a task-specific importance score that is above a threshold importance score;
including the row or the column in an adaptive attention pattern used with the machine-learning model to limit self-attention operations performed while making an inference; and
in response to an input, generating a task-specific inference for the input using the machine-learning model with the adaptive attention pattern.

15. The system of claim 14, wherein the machine-learning model is not retrained on a generic task after adding the adaptive attention pattern to the machine-learning model.

16. The system of claim 14, wherein the adaptive attention pattern assigns global attention to tokens in the row or the column.

17. The system of claim 14, wherein the adaptive attention pattern is for a single layer of the machine-learning model.

18. The system of claim 14, wherein the operations further comprise learning different adaptive attention patterns for different layers of the machine-learning model.

19. The system of claim 14, wherein the operations further comprise:
providing an output from a self-attention layer to a fully-connected layer to generate an importance measure for individual tokens; and
providing the importance measure to a sigmoid function to generate the task-specific importance score for the row or the column.

20. The system of claim 14, wherein the operations further comprise controlling a sparsity of the adaptive attention pattern to a sparsity range.
